(19) United States
(12) Patent Application Publication
(10) Pub. No.: US 2025/0282558 A1
(43) Pub. Date: Sep. 11, 2025

(54) METHOD FOR CONTROLLING A CONTAINER TREATMENT LINE AND CONTAINER TREATMENT LINE

(71) Applicant: Krones AG, Neutraubling (DE)

(72) Inventors: Niels CLAUSEN, Dollerup (DE); Thomas ALBRECHT, Beilngries (DE); Benedikt BOETTCHER, Bruckmühl (DE)

(21) Appl. No.: 19/075,146

(22) Filed: Mar. 10, 2025

(30) Foreign Application Priority Data
Mar. 11, 2024 (DE) 10 2024 106 832.9

(51) Int. Cl. B65G 43/08

(52) U.S. Cl. CPC B65G 43/08; B65G 2201/0235; B65G 2203/041

(57) ABSTRACT

A method is provided for controlling a container treatment line comprising at least one machine for container treatment, at least one transport unit for transporting the containers and a central control unit. The method comprises: receiving, in the central control unit, first control data from the at least one machine and second control data from the at least one transport unit; calculating, by a model-based control system based on the first and second control data, a first control instruction for the at least one machine and/or a second control instruction for the at least one transport unit; sending the first control instruction to the at least one machine and/or sending the second control instruction to the at least one transport unit; controlling the at least one machine according to the first control instruction and/or controlling the at least one transport unit according to the second control instruction.

### CROSS REFERENCE TO RELATED APPLICATION

The present application claims priority to German Patent Application No. 10 2024 106 832.9 filed on Mar. 11, 2024. The entire contents of the above-listed application are hereby incorporated by reference for all purposes.

### TECHNICAL FIELD

The disclosure relates to a method for controlling a container treatment line and a container treatment line.

### BACKGROUND

It is known that beverage filling lines can be controlled via jam switches and light barriers. Currently, only a few operating states, such as nominal performance at 100% and overperformance at 120%, are stored in the machines of a beverage filling line. A continuous, overarching control of beverage filling lines with regard to performance, e.g., energy consumption, line efficiency, or output, does not currently take place.

### SUMMARY

In practice, the lack of a higher-level line control can lead to situations that may result in suboptimal line behavior. For example, the container flow on the conveyors may pulsate, causing containers to tip over, leading to avoidable stop and start processes of machines and thus to increased energy consumption and reduced efficiency.

### OBJECT

The object of the disclosure is to provide a method for controlling a container treatment line and a container treatment line with which a continuous, higher-level control of the container treatment line with regard to the efficiency of the container treatment line can be made possible.

### SOLUTION

The object is achieved by the method for controlling a container treatment line and the container treatment line as described herein.

The method according to the disclosure for controlling a container treatment line, which comprises at least one machine for container treatment and at least one transport unit for transporting the containers along with a central control unit, comprises:
receiving first control data from the at least one machine in the central control unit and receiving second control data from the at least one transport unit in the central control unit,
calculating a first control instruction for the at least one machine by a model-based control system based on the first and second control data and/or calculating a second control instruction for the at least one transport unit by the model-based control system based on the first and second control data, wherein the model-based control system describes the container treatment line and is stored in the central control unit,
sending the first control instruction to the at least one machine and/or sending the second control instruction to the at least one transport unit,
controlling the at least one machine according to the first control instruction and/or controlling the at least one transport unit according to the second control instruction.

The at least one container treatment machine can comprise a depalletizer, a container cleaning machine, a heat treatment machine, such as a pasteurization machine, a blow molding machine, a filling and closing apparatus, a labeling machine, a packaging machine and/or a palletizer.

The at least one transport unit for transporting the containers can comprise a transport belt and/or an apparatus for neck handling.

Containers can be fed to a machine for container treatment by a first transport unit, and containers can be discharged from this machine by a second transport unit. For example, containers can be fed to a subsequent machine for container treatment by the second transport unit.

In general, the machines for container treatment can be connected by transport units.

The central control unit can be the only central control unit of the container treatment line.

The receiving of first control data from the at least one machine in the central control unit and the receiving of second control data from the at least one transport unit in the central control unit can be carried out continuously, substantially continuously or at predefined temporal intervals.

Using the received first and second control data, the central control unit can be informed of the current state of the machines and transport units, and thereby also, for example, of the container treatment line, which comprises at least one machine and at least one transport unit.

The first control instruction can comprise one or more first control steps for the at least one machine.

The second control instruction can comprise one or more second control steps for the at least one transport unit.

The calculation can comprise calculating an optimal transport speed in order to avoid machine downtime in the event of a machine malfunction.

The calculation can comprise calculating an optimal transport speed, for example in order to close one or more gaps in the container transport before they reach the machine and could thus lead to a malfunction of the machine.

It may thus be possible to control the container treatment line continuously, for example in a manner adjusted to the temporally dynamic behavior of the container treatment line, and not only, as previously, based on the few stored operating states (e.g., nominal performance at 100%, overperformance at 120%).

The method can further comprise receiving sensor data from at least one sensor comprised in the container treatment line in the central control unit, wherein the calculation of the first control instruction and/or the calculation of the second control instruction can be carried out based on the first and second control data and the sensor data. For example, the at least one sensor can comprise a light barrier, a pressure-sensitive switch, a microphone and/or a temperature measuring device.

The at least one sensor can be arranged on or near or above the at least one transport unit in such a way that the at least one sensor can record sensor data with respect to the at least one transport unit.

Using the received sensor data, a degree of occupancy of, for example, at least one transport unit (e.g., light barrier and/or pressure-sensitive switch and/or microphone) can be determined. For example, the degree of occupancy can be determined in the central control unit.

If the container treatment line also comprises at least one buffer device, the degree of occupancy of the at least one buffer device can be determined using the received sensor data. For example, the degree of occupancy can be determined in the central control unit. The at least one sensor can be arranged on or near or above the at least one buffer device in such a way that the at least one sensor can record sensor data with respect to the at least one buffer device.

For example, the temperature of preforms can be measured using a sensor configured as a temperature measuring device. Depending on the storage location, the preforms can have different temperatures. For example, in winter, cold outside temperatures can result in colder preforms compared to preforms that have been stored for some time in a hall in which, for example, the container treatment line is also arranged.

Based on the received sensor data, the central control unit can be given a detailed overview of the overall situation of the container treatment line.

The method can further comprise receiving camera data from at least one camera comprised in the container treatment line in the central control unit, wherein the calculation of the first control instruction and/or the calculation of the second control instruction can be carried out based on the first and second control data and/or the camera data. For example, the at least one camera can be arranged on or near or above the at least one transport unit.

The at least one camera can be arranged on or near or above the at least one transport unit and/or the at least one buffer device and/or the at least one machine in such a way that the at least one camera can record camera data with respect to the at least one transport unit and/or the at least one buffer device and/or the at least one machine.

Using the received camera data, the degree of occupancy of, for example, at least one transport unit, can be determined. For example, the degree of occupancy can be determined in the central control unit.

If the container treatment line also comprises at least one buffer device, the degree of occupancy of the at least one buffer device can be determined using the received camera data. For example, the degree of occupancy can be determined in the central control unit. The at least one camera can be arranged on or near or above the at least one buffer device in such a way that the at least one camera can record camera data with respect to the at least one buffer device.

Based on the received camera data, the central control unit can be given a detailed overview of the overall situation of the container treatment line.

It may be possible to describe the container treatment line in the material flow, for example how many containers are at which location, what percentage of a certain region of the at least one transport unit is occupied by containers per unit of time and/or how many containers are passing through a certain region of the at least one transport unit per unit of time.

The method can further comprise processing image information at or in the at least one camera prior to the (previously mentioned) receiving of camera data from at least one camera in the central control unit. Processed image information can thus be contained in the camera data, which can then be received by the central control unit. As a result, the data volume for data transport can be reduced.

Model-based control system can comprise a model-based nonlinear control approach. This may be necessary due to the complexity of the container treatment line to be controlled. For simple portions of the container treatment line, a linear controller could also be used.

The model-based control system can comprise an analytical physical model, a machine learning model, a differential equation, a neural network and/or a system model.

The central control unit can comprise a model part and an optimization part.

The model part can comprise the model-based control system.

The optimization part can perform an optimization with regard to one or more optimization objectives on the basis of the first and second control data during ongoing operation of the container treatment line, or the optimization part can perform the optimization with regard to one or more optimization objectives additionally on the basis of the first and second control data, the sensor data and/or camera data during ongoing operation of the container treatment line.

The optimization part can send optimized parameters and/or control variables to the corresponding at least one machine.

The method can further comprise monitoring the model-based control system by comparing actual values and target values of the machine based on the camera data and, if a given deviation is exceeded, performing an automatic parameter identification. The data provided by the camera can be used to monitor the quality of the model-based control system during operation of the machine and, if necessary, to adjust it.

Using the comparison, an existing deviation can be ascertained, which can then be compared with the given deviation. Automatic parameter identification can lead to a reduction of the existing deviation during further monitoring—after automatic parameter identification—of the model-based control system.

As a result, a significant improvement in the control behavior and robustness of the model-based control system can be achieved. For example, improved response options to disturbances are possible, for example by changing the friction of at least one transport unit, temperature, stickiness of the containers, belt lubrication, etc.

The method can further comprise validating the optimized parameters prior to sending. For example, validation can comprise checking based on the model-based control system whether a change achievable by applying the optimized parameters can result in a measurable improvement in the behavior of the container treatment line.

Furthermore, a container treatment line is provided, comprising at least one machine for container treatment and at least one transport unit for transporting the containers along with a central control unit, wherein the central control unit is configured for carrying out the method as described above or further below.

The at least one container treatment machine can comprise a depalletizer, a container cleaning machine, a blow molding machine, a filling and closing apparatus, a labeling machine, a packaging machine and/or a palletizer.

The at least one transport unit for transporting the containers can comprise a transport belt and/or an apparatus for neck handling.

The container treatment line can further comprise at least one camera. For example, the at least one camera can be arranged on or above the at least one transport unit.

The at least one camera can be arranged on or near or above the at least one transport unit and/or at least one buffer device in such a way that the at least one camera can record camera data with respect to the at least one transport unit and/or the at least one buffer device. The at least one buffer device can be comprised in the container treatment line.

The at least one camera is configured for processing image information on or in the at least one camera before receiving camera data from the at least one camera in the central control unit.

### BRIEF DESCRIPTION OF THE FIGURE

The accompanying figure shows, by way of example, aspects and/or embodiments of the disclosure for better understanding and illustration. In the drawings:

FIG. 1 is a structural block diagram of a container treatment line comprising machines for container treatment, transport units for transporting containers and a central control unit for carrying out a method for controlling the container treatment line.

### DETAILED DESCRIPTION OF THE FIGURE

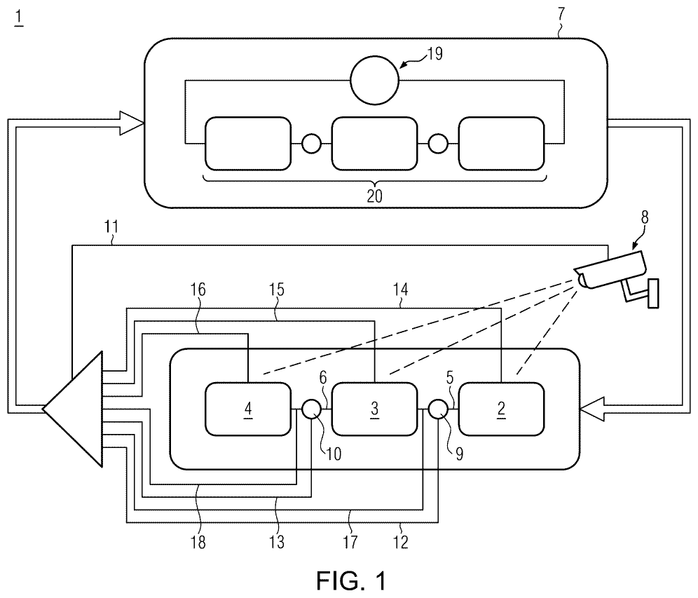

FIG. 1 is a structural block diagram of a container treatment line 1 comprising three machines 2, 3, 4 for container treatment, two transport units 5, 6 for transporting containers and a central control unit 7 for carrying out a method for controlling the container treatment line 1, for example including a processor and memory with instructions stored therein for carrying out the methods described herein, and further coupled with sensors and actuators as described herein.

Containers can, for example after a container treatment has been carried out by the first machine 2 for container treatment, be discharged from the first machine 2 by the first transport unit 5 and fed to the second machine 3 for container treatment. The containers treated in the second machine 3 can be fed to the third machine 4 for container treatment by the second transport unit 6.

By way of example, FIG. 1 shows a camera 8 by means of which camera data 11 with respect to the machines 2, 3, 4 and/or the transport units 5, 6 can be recorded. The container treatment line 1 can comprise more than one such camera 8. The at least one camera 8 can be arranged on or near or above the transport units 5, 6 and/or the machines 2, 3, 4 in such a way that the at least one camera 8 can record the camera data 11.

The camera data 11 can be sent from the camera 8 to the central control unit 7 and received in the central control unit 7.

Two sensors 9, 10 are arranged on the first transport unit 5 and the second transport unit 6 in such a way that the sensors 9, 10 can in each case record sensor data 12, 13 with respect to the first transport unit 5 and the second transport unit 6, respectively. The sensor data 12, 13 can be sent from the sensors 9, 10 to the central control unit 7 and received in the central control unit 7. The sensors 9, 10 can comprise a light barrier, a pressure-sensitive switch, a microphone and/or a temperature measuring device.

In the central control unit 7, first control data 14, 15, 16 are received from the machines 2, 3, 4 and second control data 17, 18 are received from the transport units 5, 6.

The central control unit 7 comprises an optimization part 19 and a model part 20.

In the central control unit 7, a first control instruction for the machines 2, 3, 4 is calculated by a model-based control system based on the first and second control data 14, 15, 16, 17, 18 and/or a second control instruction for the transport units 5, 6 is calculated by the model-based control system based on the first and second control data 14, 15, 16, 17, 18. The model-based control system describes the container treatment line 1 and is stored in the central control unit 7.

Alternatively, the calculation of the first control instruction and/or the calculation of the second control instruction can be carried out based on the first and second control data 14, 15, 16, 17, 18 and the sensor data 12, 13.

Alternatively, the calculation of the first control instruction and/or the calculation of the second control instruction can be carried out based on the first and second control data 14, 15, 16, 17, 18 and the camera data 11.

Alternatively, the calculation of the first control instruction and/or the calculation of the second control instruction can be carried out based on the first and second control data 14, 15, 16, 17, 18, the sensor data 12, 13 and the camera data 11.

The first control instruction can be sent to the machines 2, 3, 4 and/or the second control instruction can be sent to the transport units 5, 6. The machines 2, 3, 4 can be controlled according to the first control instruction and/or the transport units 5, 6 can be controlled according to the second control instruction.

1. A method for controlling a container treatment line, which comprises at least one machine for container treatment and at least one transport unit for transporting the containers and a central control unit, wherein the method comprises:
receiving first control data from the at least one machine in the central control unit and receiving second control data from the at least one transport unit in the central control unit,
calculating a first control instruction for the at least one machine by a model-based control system based on the first and second control data and/or calculating a second control instruction for the at least one transport unit by the model-based control system based on the first and second control data, wherein the model-based control system describes the container treatment line and is stored in the central control unit,
sending the first control instruction to the at least one machine and/or sending the second control instruction to the at least one transport unit,
controlling the at least one machine according to the first control instruction and/or controlling the at least one transport unit according to the second control instruction.

2. The method according to claim 1, further comprising:
receiving sensor data from at least one sensor comprised in the container treatment line in the central control unit,
wherein the calculation of the first control instruction and/or the calculation of the second control instruction is carried out based on the first and second control data and the sensor data.

3. The method according to claim 1, further comprising:
receiving camera data from at least one camera comprised in the container treatment line in the central control unit,
wherein the calculation of the first control instruction and/or the calculation of the second control instruction is carried out based on the first and second control data and/or the camera data.

4. The method according to claim 3, further comprising:
processing image information on or in the at least one camera before receiving camera data from at least one camera comprised in the container treatment line in the central control unit.

5. The method according to claim 1, wherein the model-based control system comprises: a model-based, non-linear control approach.

6. The method according to claim 1, wherein the model-based control system comprises: an analytical physical model, a machine learning model, a differential equation, a neural network and/or a system model.

7. The method according to claim 1, wherein the central control unit comprises a model part and an optimization part.

8. The method according to claim 7, wherein the optimization part performs an optimization with regard to one or more optimization objectives on the basis of the first and second control data during ongoing operation of the container treatment line, or wherein the optimization part performs the optimization with regard to one or more optimization objectives on the basis of the first and second control data, the sensor data and/or camera data during ongoing operation of the container treatment line.

9. The method according to claim 7, wherein the optimization part sends optimized parameters and/or control variables to the corresponding at least one machine.

10. The method according to claim 9, further comprising:
monitoring the model-based control system by comparing actual values and target values of the machine based on the camera data and, if a given deviation is exceeded,
performing an automatic parameter identification.

11. The method according to claim 9, further comprising:
validating the optimized parameters before sending.

12. A container treatment line comprising at least one machine for container treatment and at least one transport unit for transporting the containers and a central control unit, wherein the central control unit is configured for carrying out the method according to claim 1.

13. The container treatment line according to claim 12, further comprising at least one camera, wherein, the at least one camera is arranged on or above the at least one transport unit and/or the at least one machine.

14. The container treatment line according to claim 13, wherein the at least one camera is configured for processing image information on or in the at least one camera before receiving camera data from the at least one camera in the central control unit.

15. The method according to claim 2, wherein the at least one sensor comprises a light barrier, a pressure-sensitive switch, a microphone and/or a temperature measuring device.

16. The method according to claim 3, wherein the at least one camera is arranged on or above the at least one transport unit.

17. The method according to claim 11, wherein the validation comprises checking based on the model-based control system whether a change achievable by applying the optimized parameters results in a measurable improvement in the behavior of the container treatment line
